(19) United States
(12) Patent Application Publication
(10) Pub. No.: US 2003/0011626 A1
(43) Pub. Date: Jan. 16, 2003

(54) Method of driving display panel with a variable number of subfields

(75) Inventors: Takahisa Tanabe, Tsurugashima-shi (JP); Shinichi Ishizuka, Tsurugashima-shi (JP)

Correspondence Address: SUGHRUE MION, PLLC, 2100 PENNSYLVANIA AVENUE, N.W., WASHINGTON, DC, 20037, US

(73) Assignee: PIONEER CORPORATION

(21) Appl. No.: 10/191,507

(22) Filed: Jul. 10, 2002

(30) Foreign Application Priority Data
Jul. 11, 2001 (JP) 2001-210328

(51) Int. Cl. G09G 5/10

(52) U.S. Cl. 345/690

(57) ABSTRACT

A method of driving which makes it possible to drive a matrix type display panel for light emittion with low power consumption. In performing sub-field driving in which each of light-emitting devices serving as pixels in each of sub-fields constituting the display period of one field of a video signal is caused to emit light for a period associated with the sub-field according to pixel data, the number of the sub-fields is changed in accordance with the number of gray scale levels of an image represented by the video signal.

### BACKGROUND OF THE INVENTION

1. Field of the Invention

The present invention relates to a method of driving a matrix type display panel.

2. Description of Related Art

Plasma display apparatus and electro-luminescence display apparatus are currently attracting attention as a display apparatus for displaying images in accordance with an input video signal without using a CRT. Such a display apparatus employs a display panel in which a plurality of light-emitting devices serving as pixels is arranged in the form of a matrix, instead of a CRT. Sub-field method is known as a technique for displaying an image having intermediate luminance according to an input video signal on a screen constituted by the display panel mentioned above.

According to the sub-field method, each of the light-emitting devices is driven for emission in either of an “emission state” in which it emits light at a predetermined constant luminance and a “non-emission state”.

Specifically, according to the sub-field method, the display period of one field is divided into N sub-fields. A light emission driving is performed as described above by assigning a light emission period to each of the sub-fields, the light emission period being in accordance with a weight applied to each digit of the bits of pixel data (N bits of data obtained by sampling the video signal in association with each pixel).

For example, as shown in FIG. 1, when one field is divided into six sub-fields SF1 to SF6, a light emission period is assigned to each of the sub-fields SF1 to SF6 as follows.

SF1: 1

SF2: 2

SF3: 4

SF4: 8

SF5: 16

SF6: 32

For example, let us assume that emission is caused only in the sub-field SF6 among the sub-fields SF1 to SF6. Then, since light emission is caused only in the period “32” within the display period of the field, luminance in accordance with period “32” is perceived by human eyes. Also, let us assume that light emission is caused in the sub-fields SF1 to SF5 excluding the sub-field SF6. Then, since light emission is caused in a period “1”+“2”+“4”+“8”+“16”=“31” within the display period of one field, luminance in accordance with the period “31” is perceived by human eyes.

Thus, it is possible to display various levels of intermediate luminance in ₂^{N} (N represents the number of sub-fields) steps (hereinafter referred to as gray scale levels) by combining sub-fields in which emission is caused within the display period of one field.

However, the driving scheme using the sub-field method has had a problem in that power consumption is increased as the number of sub-fields increases because all light-emitting devices in a display panel are driven in each sub-field.

### SUMMARY OF THE INVENTION

The invention has been conceived to solve such a problem and provides a method of driving which makes it possible to drive a matrix type display panel for light emission with low power consumption.

A method of driving a display panel according to the invention is a method of driving a display panel in which a display panel having a plurality of light-emitting devices serving as pixels arranged in the form of a matrix is driven in accordance with pixel data of each of the pixels based on a video signal, performing a sub-field driving which causes the light-emitting devices in each of sub-fields which together constitute a display period of one field of the video signal to emit light in a period associated with the sub-field according to the pixel data, wherein the number of the sub-fields of each field is changed according to the number of displaying gray scale levels of a display image represented by the video signal.

As described above, in the invention, in a gray scale driving of a matrix type display panel according to the sub-field method, the number of sub-fields is reduced when displaying an image having a small number of display gray scale levels.

Therefore, according to the invention, power consumption is reduced in proportion to the reduction in number of sub-fields.

### BRIEF DESCRIPTION OF THE DRAWINGS

FIG. 1 is a diagram showing an example of a driving format for light emission and a gray scale driving operation based on the sub-field method;

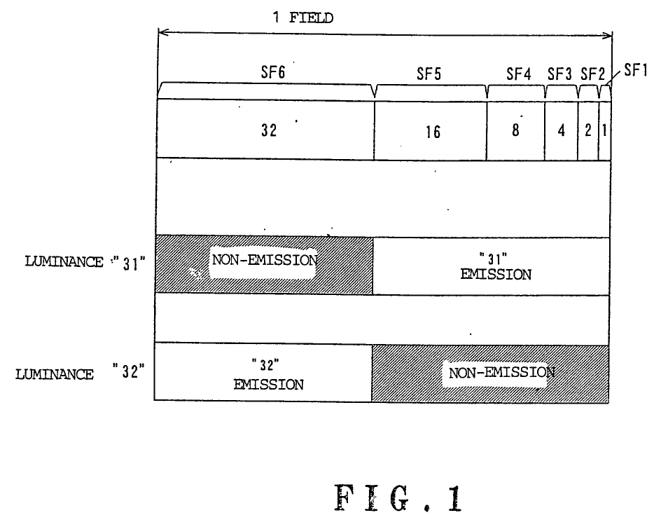

FIG. 2 is a block diagram schematically showing the configuration of an EL display apparatus in which a display panel is driven based on a driving method according to the invention;

FIG. 3 is a diagram showing an example of the internal configuration of an EL unit E serving as each of pixels of a display panel 10 provided in the EL display apparatus shown in FIG. 2;

FIGS. 4A and 4B are diagrams showing examples of emission driving formats based on the method of driving of the invention;

FIG. 5 is a diagram showing a memory map of a cumulative luminance frequency memory provided in a gray scale number judging circuit 22;

FIG. 6 is a diagram showing the configuration of an EL display apparatus according to another embodiment of the invention;

FIG. 7 shows a routine for judging a diplay image having a small number of gray scale levels which is executed by a driving control circuit 30′ of the EL display apparatus shown in FIG. 6; and

FIGS. 8A to 8H are diagrams showing other examples of emission driving formats based on the method of driving of the invention.

### DETAILED DESCRIPTION OF THE PREFERRED EMBODIMENTS

Preferred embodiments of the invention will now be described in detail with reference to the drawings.

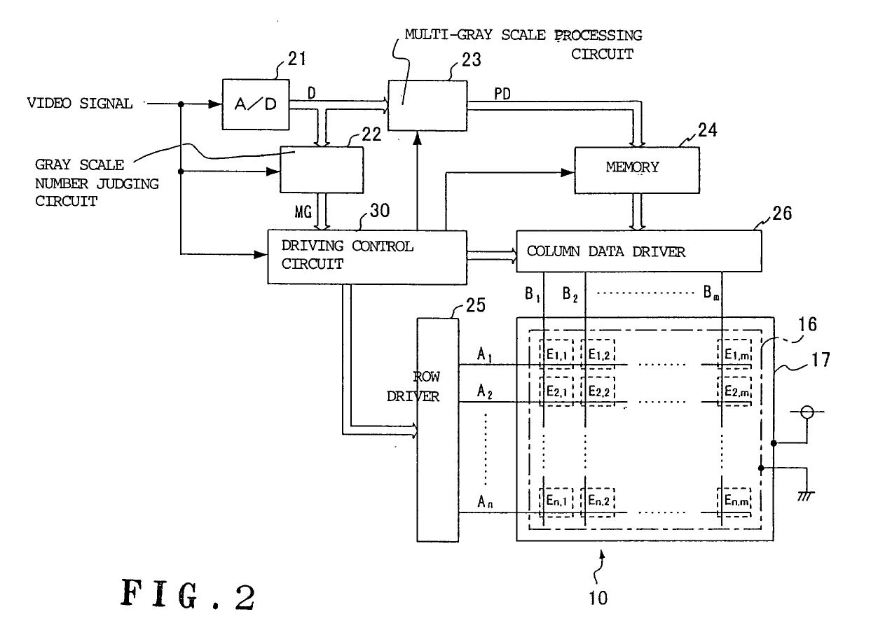

FIG. 2 shows a configuration of an electro-luminescence display apparatus (hereinafter referred to as EL display apparatus) in which a display panel is driven according to the inventive method of driving.

As shown in FIG. 2, the EL display apparatus is constituted by a display panel 10 serving as a display screen and a driving section having an A-D converter 21, a gray scale number judging circuit 22, a multi-gray scale processing circuit 23, a memory 24, a row driver 25, a column data driver 26, and a driving control circuit 30.

The display panel 10 is formed with a common ground electrode 16, a common power source electrode 17, scan lines A₁ to Aₙ respectively serving as n horizontal scan lines of one screen, and m data lines B₁ to Bₘ arranged such that they intersect with each of the scan lines. Further, EL units E_{1,1} to E_{n,m} to serve as pixels are formed at the intersections between the scan lines A₁ to Aₙ and the data lines B₁ to Bₘ in the form of a matrix.

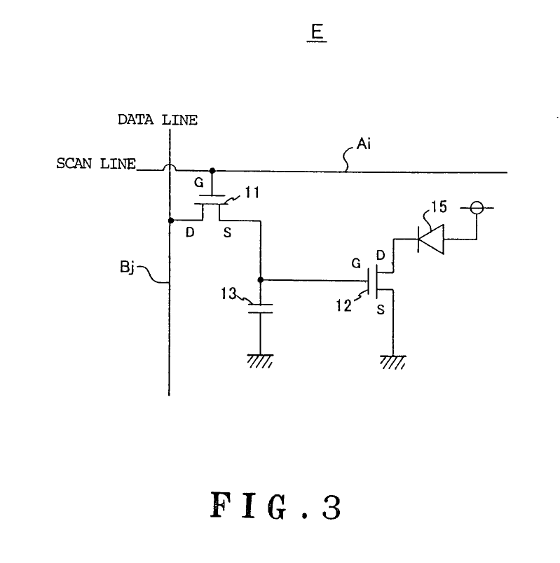

FIG. 3 shows an example of an internal configuration of an EL unit E formed at the intersection between one scan line Aᵢ and data line Bⱼ.

In FIG. 3, the scan line Aᵢ is connected to a gate G of an FET (field effect transistor) 11, and the data line Bⱼ is connected to a drain D of the same. A capacitor 13 for holding pixel data and a gate G of an FET 12 are connected to a source S of the FET 11. A ground potential is applied to a source S of the FET 12 through the common ground electrode 16, and an anode end of an organic electro-luminescence device 15 (hereinafter simply referred to as “EL device 15”) is connected to a drain D of the same.

The A-D converter 21 of the driving section converts an input video signal into, for example, 8 bits of pixel data D associated with each pixel and supplies the data to the gray scale number judging circuit 22 and the multi-gray scale processing circuit 23.

The multi-gray scale processing circuit 23 performs multi-gray scale processing operations such as a dithering process and an error diffusion process on the pixel data D sequentially supplied from the A-D converter 21 and supplies resultant multi-gray scale pixel data PD to the memory 24. When a multi-gray scale processing stop command is supplied from the driving control circuit 30, the multi-gray scale processing circuit 23 stops the multi-gray scale processing operations as described above and supplies the pixel data D supplied by the A-D converter 21 to the memory 24 as they are as multi-gray scale pixel data PD.

The gray scale number judging circuit 22 sequentially takes in pixel data D₁ to Dₙₘ for one screen (having n rows and m columns). The data D₁ to Dₙₘ are, for example, received in groups each containing data to display read, green, and blue, respectively. The gray scale number judging circuit 22 judges the number of gray scale levels existing in the display image represented by the pixel data for one screen thus taken in for each of the colors red, green, and blue. The gray scale number judging circuit 22 supplies the number of gray scale levels existing in a red component of the display image, the number of gray scale levels existing in a green component of the display image, and the number of gray scale levels existing in a bule component of the display image to the driving control circuit 30 as gray scale number data MG_{R}, gray scale number data MG_{G}, and gray scale number data MG_{B}, respectively.

For example, the gray scale number judging circuit 22 has a sum memory having 256 storage areas for each color, the storage areas being respectively associated with all gray scale steps, or levels, 0 to 255 that can be expressed by the pixel data D. Stored in each of the areas are cumulative total data YR₀ to YR₂₅₅ (data associated with red), cumulative total data YG₀ to YG₂₅₅ (data associated with green), and cumulative total data YB₀ to YB₂₅₅ (data associated with blue) each representing the cumulative number of times the pixel data D having the relevant gray scale level has been supplied. When the gray scale number judging circuit 22 detects a vertical synchronization signal from the input video signal, it initializes all of the values of the cumulative total data YR₀ to YR₂₅₅, the cumulative total data YG₀ to YG₂₅₅, and the cumulative total data YB₀ to YB₂₅₅ to 0. Thereafter, each time the pixel data for one pixel is supplied from the A-D converter 21, the gray scale number judging circuit 22 increments only the cumulative total data (YR, YG, or YB) associated with the gray scale level of the luminance of the pixel data D by one. When the above-described process is completed for the pixel data D₁ to Dₙₘ for one screen, the gray scale number judging circuit 22 first counts the number of cumulative total data YR having a cumulative total of “1” or more among the cumulative total data YR₀ to YR₂₅₅ and supplies the number to the driving control circuit 30 as gray scale number data MG_{R}. Next, the gray scale number judging circuit 22 counts the number of cumulative total data YG having a cumulative total of “1” or more among the cumulative total data YG₀ to YG₂₅₅ and supplies the number to the driving control circuit 30 as gray scale number data MG_{G}. Then, the gray scale number judging circuit 22 counts the number of cumulative total data YB having a cumulative total of “1” or more among the cumulative total data YB₀ to YB₂₅₅ and supplies the number to the driving control circuit 30 as gray scale number data MG_{B}.

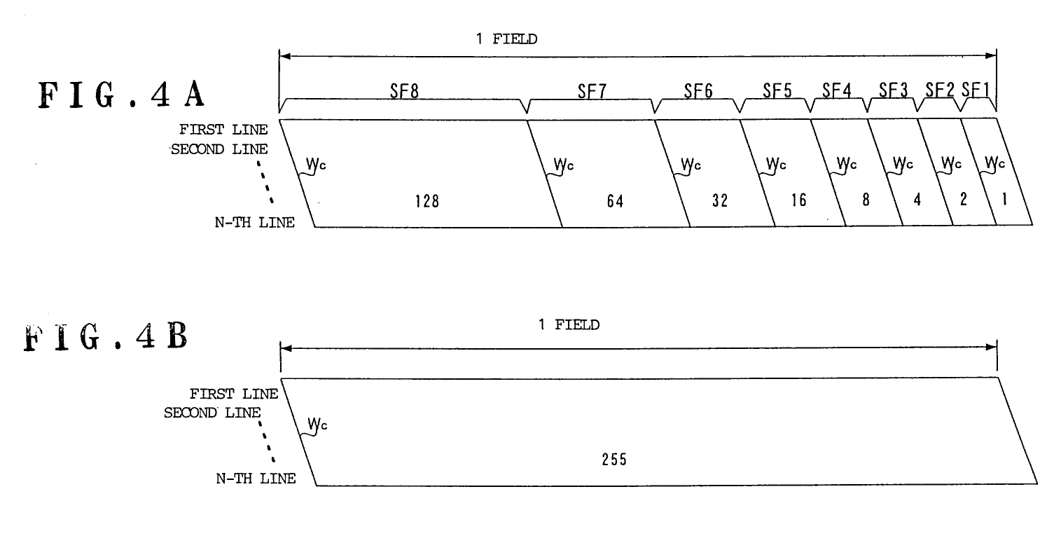

The driving control circuit 30 controls each of the memory 24, the row driver 25, and the column data driver 26 to drive the display panel 10 in accordance with an emission driving format as shown in FIG. 4A or 4B for which the sub-field method is employed.

When at least one of the gray scale number data MG_{R}, MG_{G}, and MG_{B} indicates 3 or more gray scale levels, the driving control circuit 30 drives the display panel 10 using the emission driving format shown in FIG. 4A. When all of the gray scale number data MG_{R}, MG_{G}, and MG_{B} indicate 2 or less gray scale levels, the display panel 10 is driven using the emission driving format shown in FIG. 4B.

In the emission driving format shown in FIG. 4A, the display period of one field is divided into eight sub-fields SF1 to SF8, and pixel data for one scan line are written in the EL units E at a time in each of the sub-fields (pixel data writing process W_{C}). In this driving process, light emission periods having the ratios to the shortest light emission period SF1 as shown below are assigned as the sub-fields SF1 to SF8 respectively.

SF1: 1

SF2: 2

SF3: 4

SF4: 8

SF5: 16

SF6: 32

SF7: 64

SF8: 128

In the emission driving format shown in FIG. 4B, the sub-fields as described above are not provided, and the pixel data writing process W_{C} is performed only once at the beginning of the display period of one field.

To perform a driving process based on the light emission driving format shown in FIG. 4A, the driving control circuit 30 controls each of the memory 24, the row driver 25, and the column data driver 26 in a multi-gray scale mode as described below.

(1) Multi-Gray Scale Mode

The multi-gray scale pixel data PD are sequentially written in the memory 24, and data are read out as follows when the writing of the multi-gray scale pixel data PD₁ to PDₙₘ for one screen is completed. First, only the eighth bit (most significant bit) of each of the multi-gray scale pixel data PD₁ to PDₙₘ is extracted from the memory 24, and those bits are read and supplied to the column data driver 26 in a quantity for one scan line (m bits) at a time when the process W_{C} is performed to write pixel data in the sub-field SF8 as shown in FIG. 4A. Next, only the seventh bit of each of the multi-gray scale pixel data PD₁ to PDₙₘ is extracted from the memory 24, and those bits are read and supplied to the column data driver 26 in a quantity for one scan line at a time when the process W_{C} is performed to write pixel data in the sub-field SF7 as shown in FIG. 4A. Next, only the sixth bit of each of the multi-gray scale pixel data PD₁ to PDₙₘ is extracted from the memory 24, and those bits are read and supplied to the column data driver 26 in a quantity for one scan line at a time when the process W_{C} is performed to write pixel data in the sub-field SF6 as shown in FIG. 4A. Next, only the fifth bit of each of the multi-gray scale pixel data PD₁ to PDₙₘ is extracted from the memory 24, and those bits are read and supplied to the column data driver 26 in a quantity for one scan line at a time when the process W_{C} is performed to write pixel data in the sub-field SF5 as shown in FIG. 4A. Next, only the fourth bit of each of the multi-gray scale pixel data PD₁ to PDₙₘ is extracted from the memory 24, and those bits are read and supplied to the column data driver 26 in a quantity for one scan line at a time when the process W_{C} is performed to write pixel data in the sub-field SF4 as shown in FIG. 4A. Next, only the third bit of each of the multi-gray scale pixel data PD₁ to PDₙₘ is extracted from the memory 24, and those bits are read and supplied to the column data driver 26 in a quantity for one scan line at a time when the process W_{C} is performed to write pixel data in the sub-field SF3 as shown in FIG. 4A. Next, only the second bit of each of the multi-gray scale pixel data PD₁ to PDₙₘ is extracted from the memory 24, and those bits are read and supplied to the column data driver 26 in a quantity for one scan line at a time when the process W_{C} is performed to write pixel data in the sub-field SF2 as shown in FIG. 4A. Next, only the first bit (least significant bit) of each of the multi-gray scale pixel data PD₁ to PDₙₘ is extracted from the memory 24, and those bits are read and supplied to the column data driver 26 in a quantity for one scan line at a time when the process W_{C} is performed to write pixel data in the sub-field SF1 as shown in FIG. 4A.

The column data driver 26 generates m driving pulses GP₁ to GPₘ in accordance with the logical level of each of the (m) pixel data bits for one scan line read from the memory 24 and applies them to the data lines B₁ to Bₘ of the display panel 10, respectively. For example, the column data driver 26 generates a driving pulse GP which is at a predetermined high voltage when the logical level of a pixel data bit is “1” and which is at a low voltage (0 volt) when the logical level is “0”. The row driver 25 sequentially applies scan pulses SP to each of the scan lines A₁ to Aₙ of the display panel 10 in synchronism with the timing of the application of the driving pulses GP₁ to GPₘ at the process W_{C} of writing pixel data in each sub-field as shown in FIG. 4A.

Aa result, the FET 11 of each of the EL units on the scan line Aᵢ to which the scan pulse SP is applied is turned on to lead the driving pulse GP applied to the data line Bⱼ to the capacitor 13 and the gate G of the FET 12. When a driving pulse GP at the high voltage is applied, the capacitor 13 is charged to maintain a gate voltage of the FET 12 at a high voltage. When a driving pulse GP at the low voltage is applied, the capacitor 13 is discharged, and charges that have been held until that time disappear. That is, pixel data are written in the capacitor 13. Therefore, when the capacitor 13 is charged, since the gate voltage of the FET 12 is kept at the high voltage to turn the FET 12 on, a light emission starting current flows into the EL device 15 to put the EL device 15 in a so-called “emission state in which it emits light with predetermined luminance. When the capacitor 13 is discharged, the gate voltage of the FET 12 is kept at the low voltage to keep the FET 12 off, which puts the EL device 15 in a “non-emission state”.

When the period “128” elapses after the pixel data writing process W_{C} in the sub-field SF8 shown in FIG. 4A is completed, the driving control circuit 30 resumes the pixel data writing process W_{C} in the sub-field SF7. When the period “64” elapses after the pixel data writing process W_{C} in the sub-field SF7 is completed, the driving control circuit 30 causes the pixel data writing process W_{C} to be performed in the sub-field SF6 and causes the pixel data writing process W_{C} to be performed in the sub-field SF5 when the period “32” elapses further. Similarly, when the period “16” elapses after the pixel data writing process W_{C} in the sub-field 5 is completed, the driving control circuit 30 causes the pixel data writing process W_{C} to be preformed in the sub-field SF4 and causes the pixel data writing process W_{C} to be performed in the sub-field SF3 when the period “8” elapses further. When the period “4” elapses after the pixel data writing process W_{C} in the sub-field SF3 is completed, the driving control circuit 30 causes the pixel data writing process W_{C} to be preformed in the sub-field SF2 and causes the pixel data writing process W_{C} to be performed in the sub-field SF1 when the period “2” elapses further.

That is, the an EL device 15 stays in the “emission state” or “non-emission state” according to pixel data written by the pixel data writing process W_{C} until the pixel data writing process W_{C} is performed for the next sub-field SF.

Therefore, driving based on the emission driving format as shown in FIG. 4A makes it possible to display a range of gray scale levels from “0” to “255”, that is, 256 steps (levels) of gray scale levels by combining sub-fields that are in the “emission state” as described above.

When driving is performed using the emission driving format shown in FIG. 4B, the driving control circuit 30 controls each of the multi-gray scale processing circuit 23, the memory 24, the row driver 25, and the column data driver 26 in a small gray scale number mode as described below.

(2) Small Gray Scale Number Mode

First, the driving control circuit 30 supplies a multi-gray scale processing stop command to the multi-gray scale processing circuit 23. According to the multi-gray scale processing stop command, the multi-gray scale processing circuit 23 stops the multi-gray scale processing operations such as the dithering process and error diffusion process and supplies pixel data D supplied from the A-D converter 21 directly to the memory 24 as multi-gray scale pixel data PD. Multi-gray scale pixel data PD for each screen (PD₁ to PDₙₘ) are written in the memory 24. In this process, the small gray scale number mode is enabled only when the gray scale number data MG represents 2 or less gray scale levels, the multi-gray scale pixel data PD₁ to PDₙₘ written in the memory 24 can only have either of a first value and a second value smaller than the first valur. When the writing of the multi-gray scale pixel data PD₁ to PDₙₘ for one screen is completed, the multi-gray scale pixel data PD₁ to PDₙₘ are read in the quantity (m) for one scan line at a time from the memory 24. The memory 24 converts each item of the multi-gray scale pixel data PD into a pixel data bit at the logical level “1” when the item has the first value and into a pixel data bit at the logical level “0” when the item has the second value and supplies the resultant bit to the column data driver 26.

The column data driver 26 generates m driving pulses GP₁ to GPₘ in accordance with the logical level of each of pixel data bits for one scan line (m bits) supplied from the memory 24 and applies them to the data lines B₁ to Bₘ of the display panel 10, respectively. For example, the column data driver 26 generates a driving pulse GP which is at a predetermined high voltage when the logical level of the pixel data bit is “1” and which is at a low voltage (0 volt) when the logical level is “0”. The row driver 25 sequentially applies scan pulses SP to each of the scan lines A₁ to Aₙ of the display panel 10 at a pixel data writing process W_{C} performed only in the beginning of the display period of one field in synchronism with the timing of application of the driving pulses GP₁ to GPₘ, as shown in FIG. 4B.

As a result, the FET 11 of each of the EL units on the scan line Aᵢ to which the scan pulses SP are applied turns on to lead the driving pulse GP applied to the data line Bⱼ to the capacitor 13 and the gate G of the FET 12. When a driving pulse GP at a high voltage is applied, the capacitor 13 is charged to keep the gate voltage of the FET 12 at the high voltage. When a driving pulse GP at a low voltage is applied, the capacitor 13 is discharged, and charges that have been held until that time disappear. That is, pixel data are written in the capacitor 13. Therefore, when the capacitor 13 is charged, since the gate voltage of the FET 12 is kept at the high voltage to turn on the FET 12, a light emission starting current flows into the EL device 15 to cause the EL device 15 to emit light with predetermined luminance. The “emission state” continues through the display period of the field as shown in FIG. 48. When the capacitor 13 is discharged, since the gate voltage of the FET 12 is kept at the low voltage to keep the FET 12 off, the EL device 15 stays in the “non-emission state” through the display period of the field as shown in FIG. 4B.

Therefore, when driving is performed in the small gray scale number mode based on the emission driving format as shown in FIG. 4B, luminance is displayed in two steps, i.e., the gray scale level “0” and the gray scale level “255”.

Specifically, when an input video signal itself represents a display image of only two gray scale levels or less, there is no need for performing the driving capable of displaying an image in 256 gray scale levels as shown in FIG. 4A. Therefore, when an input video signal represents a display image having only two gray scale levels, driving is performed based on the emission driving format that allows the display of an image only in two gray scale levels as shown in FIG. 4B. In the driving format shown in FIG. 4B, the pixel data writing process W_{C} is performed only once in the display period of one field. Therefore, an EL device 15 changes from the “emission state” to the “non-emission state” or from the “non-emission state” to the “emission state” at a lower frequency and consumes less power accordingly when compared to the case in which the pixel data writing process W_{C} is performed in each sub-field as shown in FIG. 4A. Further, when an input video signal represents an image having only two gray scale levels or less of luminance, since no multi-gray scale processing is required, the multi-gray scale processing operations at the multi-gray scale processing circuit 23 are stopped to suppress power consumption.

In the above embodiment, driving is performed based on the emission driving format shown in FIG. 4B only when all of the gray scale number data MG_{R}, MG_{G}, and MG_{B} represent 2 or less gray scale levels. However, driving may be performed based on the emission driving format shown in FIG. 4B when the following conditions are satisfied even if at least one of the data MG_{R}, MG_{G}, and MG_{B} represents 3 or more gray scale levels.

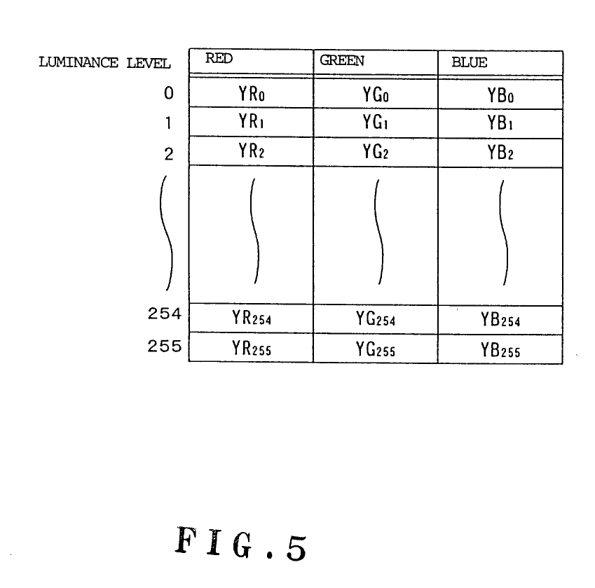

Specifically, driving is performed based on the emission driving format shown in FIG. 4B when the sum of items of data having the maximum cumulative total and the second highest cumulative total among the cumulative total data YR₀ to YR₂₅₅ (or YG₀ to YG₂₅₅ or YB₀ to YB₂₅₅) shown in FIG. 5 is in a ratio to the entire data (for one screen) that is greater than a predetermined ratio (70%, for example). In this case, the gray scale number judging circuit 22 supplies cumulative total data YR_{MAX} and cumulative total data YR_{MIN} respectively representing the maximum cumulative total and the second highest cumulative total among the cumulative total data YR₀ to YR₂₅₅ to the driving control circuit 30 instead of the gray scale number data MG_{R}. The gray scale number judging circuit 22 supplies cumulative total data YG_{MA} and cumulative total data YG_{MIN} respectively representing the maximum cumulative total and the second highest cumulative total among the cumulative total data YG₀ to YG₂₅₅ to the driving control circuit 30 instead of the gray scale number data MG_{G}. Further, the gray scale number judging circuit 22 supplies cumulative total data YB_{MAX} and cumulative total data YB_{MIN} respectively representing the maximum cumulative total and the second highest cumulative total among the cumulative total data YB₀ to YB₂₅₅ to the driving control circuit 30 instead of the gray scale number data MG_{B}. In this case, the driving control circuit 30 performs driving based on the emission driving format in FIG. 4B when any of the sum of the cumulative total data YR_{MAX} and YR_{MIN}, the sum of the cumulative total data YG_{MAX} and YG_{MIN}, and the sum of the cumulative total data YB_{MAX} and YB_{MIN} is at a ratio of 70% or more to the total frequency (for one screen=n×m/3).

In the above embodiment, the occurence of each luminance level is obtained as shown in FIG. 5 for pixel data D₁ to Dₙₘ for one screen and, when only two or less gray scale levels has a total of “1” or more, the driving is performed according to the emission driving format shown in FIG. 4B based on a judgment that the image for one screen has two or less gray scale levels. However, the method of judging whether the image for one screen is a small gray scale number image having two or less gray scale levels is not limited to the above embodiment.

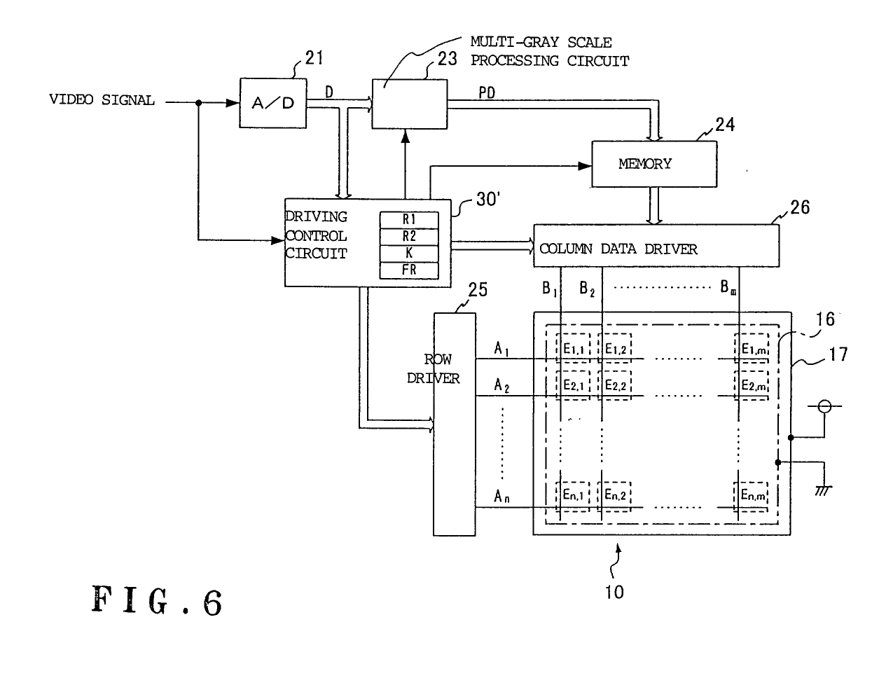

FIG. 6 shows a configuration of an EL display apparatus according to another embodiment of the invention conceived taking such a point into consideration.

Referring to FIG. 6, the operation of each of a display panel 10, an A-D converter 21, a multi-gray scale processing circuit 23, a memory 24, a row driver 25, and a column data driver 26 will not be described because it is the same as that shown in FIG. 2. In the EL display apparatus shown in FIG. 6, the gray scale number judging circuit 22 shown in FIG. 2 is omitted, and a driving control circuit 30′ is used instead of the driving control circuit 30 shown in FIG. 2. The driving control circuit 30′ performs control similarly to the driving control circuit 30 described above and judges whether an image of one screen based on pixel data D supplied from the A-D converter 21 is a small gray scale number image having two or less gray scale levels. Only the operation of judging a small gray scale number image performed by the driving control circuit 30′ will be described below.

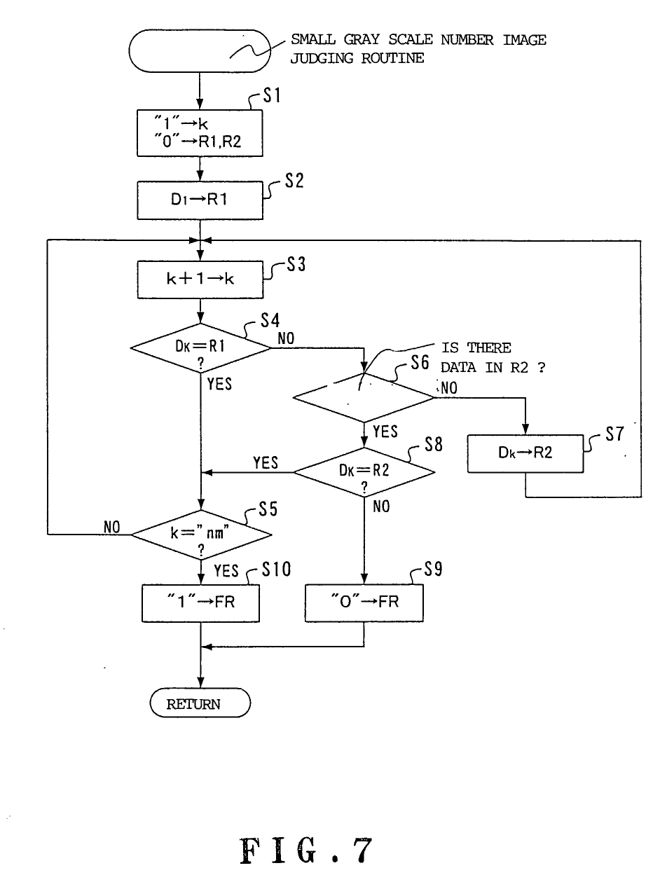

The driving control circuit 30′ sequentially accepts the pixel data D supplied by the A-D converter 21 and holds data (D₁ to Dₙₘ) for each screen. Each time a vertical synchronization signal is detected from an input video signal, the driving control circuit 30′ executes a small gray scale number image judging routine that is shown in FIG. 7.

Referring to FIG. 7, the driving control circuit 30′ first initializes a register k incorporated therein to “1” and each of registers R1 and R2 incorporated therein to “0” (step S1). Next, the driving control circuit 30′ stores the first pixel data D₁ among the pixel data D₁ to Dₙₘ for one screen held as described above in the built-in register R1 (step S2). Next, the driving control circuit 30′ rewrites the value in the built-in register k with a value obtained by adding 1 to the value in the built-in register k(step 3). Next, the driving control circuit 30′ judges whether the value of the pixel data Dₖ represented by the value in the built-in register k is the same as the value of the pixel data D₁ stored in the built-in register R1 (step S4). When it is judged at such a step S4 that the values agree with each other, the driving control circuit 30′ judges whether the value in the built-in register k agrees with “nm” (step S5). When it is judged at step S5 that the value in the built-in register k does not agree with “nm”, the driving control circuit 30′ returns to step S3 to repeat the above-described operations.

When it is judged at step S4 that the value of the pixel data Dₖ represented by the value in the built-in register k is not the same as the value of the pixel data D₁ stored in the built-in register R1, the driving control circuit 30′ judges whether any pixel data is stored in the built-in register R2 (step S6). When it is judged at such a step S6 that no pixel data is stored in the built-in register R2, the driving control circuit 30′ stores the value of the pixel data Dₖ in the built-in register R2 (step S7). After the step S7 is executed, the driving control circuit 30′ returns to step S3 to repeat the above-described operations.

When it is judged at step S6 that pixel data is stored in the built-in register R2, the driving control circuit 30′ judges whether the value of the pixel data stored in the built-in register R2 is the same as the value of the pixel data Dₖ (step S8). When it is judged at step S8 that the values agree with each other, the driving control circuit 30′ proceeds to the execution of step S5.

When it is judged at step S8 that the value of the pixel data stored in the built-in register R2 is not the same as the value of the pixel data Dₖ, the driving control circuit 30′ stores a small gray scale number image judgment flag at the logical level “0” indicating that the image for one screen is a multi-gray scale image having three or more gray scale levels in a flag register FR (step S9). When it is judged at step S5 that the value in the built-in register k agrees with nm”, the driving control circuit 30′ stores a small gray scale number image judgment flag at the logical level “1” indicating that the image for one screen is a small gray scale number image having two gray scale levels or less in the flag register FR (step S10).

After steps S9 and S10 are executed, the driving control circuit 30′ leaves the small gray scale number image judgment routine shown in FIG. 7 to return to a main routine that is not shown. At this time, the driving control circuit 30′ performs driving based on the light emission driving format in FIG. 4A when the small gray scale number judgment flag stored in the flag register FR is at the logical level “0”. When the small gray scale number judgment flag stored in the flag register FR is at the logical level “1”, the driving control circuit 30′ performs driving based on the emission driving format in FIG. 4B.

According to the method of judging a small gray scale number image described above, since there is no need for the gray scale number judging circuit 22 having a storage area for each luminance level as shown in FIG. 5, a simple configuration can be employed.

In the above embodiment, driving is performed using the emission driving format constituted by eight sub-fields shown in FIG. 4A any time when luminance levels represented by an image for one screen have 3 or more gray scale levels. However, the number of gray scale levels of an image for one screen may be classified into N ranks, and driving may be performed by providing emission driving formats formed by different numbers of sub-fields associated with the ranks respectively.

For example, the gray scale is classified into eight ranks as follows.

First Rank: “1” to “2”

Second Rank: “3” to “4”

Third Rank: “5” to “8”

Fourth Rank: “9” to “16”

Fifth Rank: “17” to “32”

Sixth Rank: “33” to “64”

Seventh Rank: “65” to “128”

Eighth Rank: “129” to “256”

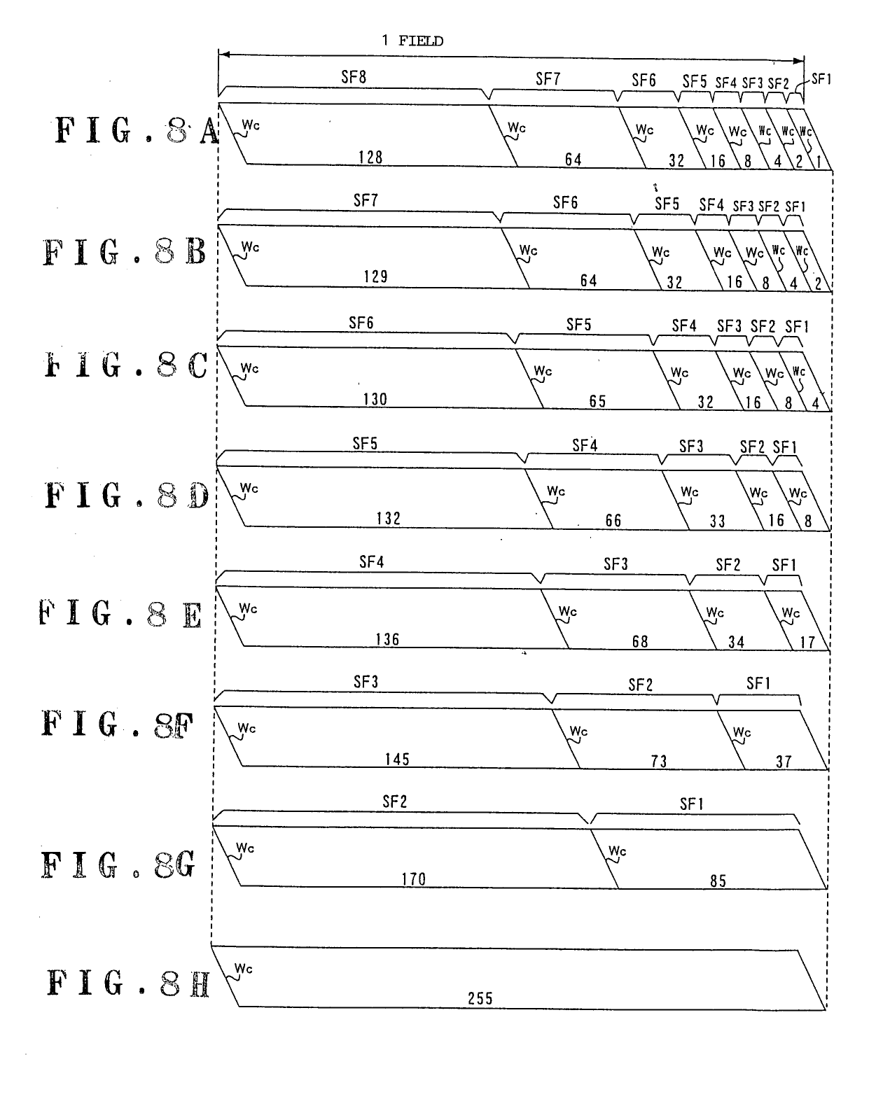

When the gray scale number data MG supplied by the gray scale number judging circuit 22 falls under the eighth rank, the driving control circuit 30 controls driving based on an emission driving format as shown in FIG. 8A. Specifically, when the gray scale levels of an image for one screen are within the range from “129” to “256”, a driving process with 256 gray scale levels are performed using the eight sub-fields SF1 to SF8 in the same manner as that shown in FIG. 4A. When the gray scale number data MG falls under the seventh rank, the driving control circuit 30 performs a drive control based on an emission driving format as shown in FIG. 8B. Specifically, when the gray scale levels of an image for one screen are within the range from “65” to “128”, a driving process with 128 gray scale levels is performed using the seven sub-fields SF1 to SF7 as shown in FIG. 8B. When the gray scale number data MG falls under the sixth rank, the driving control circuit 30 performs a driving control based on an emission driving format as shown in FIG. 8C. Specifically, when the gray scale levels of an image for one screen are within the range from “33” to “64”, 64 gray scale levels are driven using the six sub-fields SF1 to SF6 as shown in FIG. 8C. When the gray scale number data MG falls under the fifth rank, the driving control circuit 30 performs a drive control based on an emission driving format as shown in FIG. 8D. Specifically, when the gray scale levels of an image for one screen are within the range from “17” to “32”, a driving proces with 32 gray scale levels is performed using the five sub-fields SF1 to SF5 as shown in FIG. 8D. When the gray scale number data MG falls under the fourth rank, the driving control circuit 30 performs a driving control based on an emission driving format as shown in FIG. 8E. Specifically, when the gray scale levels of an image for one screen are within the range from “9” to “16”, a driving process with 16 gray scale levels is performed using the four sub-fields SF1 to SF4 as shown in FIG. 8E. When the gray scale number data MG falls under the third rank, the driving control circuit 30 performs a driving control based on an emission driving format as shown in FIG. 8F. Specifically, when the gray scale levels of an image for one screen are within the range from “5” to “8”, a driving process with 8 gray scale levels is performed using the three sub-fields SF1 to SF3 as shown in FIG. 8F. When the gray scale number data MG falls under the second rank, the driving control circuit 30 performs a driving control based on an emission driving format as shown in FIG. 8G. Specifically, when the gray scale levels of an image for one screen are within the range from “3” to “4”, a driving process with 4 gray scale levels is performed using the two sub-fields SF1 and SF2 as shown in FIG. 8G. When the gray scale number data MG falls under the first rank, the driving control circuit 30 performs a driving control based on an emission driving format as shown in FIG. 8H. Specifically, when the gray scale levels of an image for one screen are within the range from “1” to “2”, a driving proess with 2 gray scale levels is performed in the same manner as that shown in FIG. 4B.

While the number of gray scale levels of an image for each screen (image formed by pixel data for one field) is obtained based on pixel data for that screen in the gray scale number judging circuit 22, this is not limiting the invention. For example, the gray scale number judging circuit 22 may obtain a cumulative total of each gray scale level based on pixel data associated with each pixel in a predetermined area of one screen or pixel data for a plurality of screens and may obtain the gray scale based on the number of gray scale levels whose cumulative total is one or more. Alternatively, the gray scale number judging circuit 22 may obtain a cumulative total of each gray scale level of pixel data acquired in a predetermined period and may obtain the number of gray scale levels based on the number of gray scale levels whose cumulative total is one or more.

In the above embodiment, the light emission period of each sub-field is weighted as shown in FIG. 4A and FIGS. 8A to 8G in performing driving based on the sub-field method. However, the invention may be applied to any light emission driving format in which no weighting is performed on the emission period of each sub-field.

Although the driving process is performed by selecting a light emission driving format that at least allows display of the gray scale levels of an image represented by an input video signal, for example, from among those shown in FIGS. 8A to 8G in the above embodiment, this is not limiting the invention. For example, information of gray scale levels that can be represented by an input video signal may be added to the input video signal, and a litht emission driving format that at least allows a display with gray scale levels indicated by the information of gray scale levels may be selected. When an equipment having an EL display apparatus as shown in FIGS. 2 and 6 is not operated for a long time, emission driving formats may be switched such that the number of sub-fields is gradually reduced as shown in FIGS. 8A, 8B, . . . , 8H, for example. The operation of switching emission driving formats to reduce the number of sub-fields may be manually performed through a user's operation.

While the above embodiment has referred to an example of driving of a display panel having actively driven EL units as shown in FIG. 3 as light-emitting devices serving as pixels of the display panel, the invention may be similarly applied to passively driven EL devices or a plasma display panel. In this case, when the passively driven EL devices or plasma display panel is driven according to the driving method of the present invention, since the number of times of charging and discharging performed in the display period of one field can be reduced, a reduction in power consumption can be achieved accordingly.

As described above in detail, according to the invention, when a matrix type display panel is driven based on the sub-field method to display gray scale levels, the number of sub-fields is reduced during display of an image of a small number of gray scale levels.

Therefore, the invention makes it possible to achieve a reduction in power consumption according to the reduction in the number of sub-fields.

This application is based on Japanese Patent Application No. 2001-210328 which is herein incorporated by reference.

What is claimed is:

1. A method of driving a display panel in which a display panel having a plurality of light-emitting devices serving as pixels arranged in the form of a matrix is driven in accordance with pixel data of each of the pixels based on a video signal, wherein in performing a sub-field driving to cause the light-emitting devices in each of sub-fields which constitute the display period of one field of the video signal to emit light in a period associated with the sub-field according to the pixel data, the number of the sub-fields of each field is changed according to the number of gray scale levels of an image represented by the video signal.

2. A method of driving a display panel according to claim 1, wherein the sub-fields are provided in the display period of one field in number which becomes smaller as the number of gray scale levels of the luminance represented by the video signal decreases.

3. A method of driving a display panel according to claim 1, wherein a multi-gray scale processing is performed on the pixel data when the number of gray scale levels of the image represented by the video signal is greater than a predetermined number and wherein the multi-gray scale processing is stopped when the number of gray scale levels is smaller than the predetermined number.

4. A method of driving a display panel according to claim 1, comprising the steps of:
obtaining a cumulative total of each of gray scale levels of the luminance based on the pixel data;
generating cumulative total data representing the cumulative total in association with each of the gray scale levels of the luminance; and
obtaining said number of gray scale levels based on the number of cumulative total data of which the cumulative total is 1 or more among cumulative total data having been generated.

5. A method of driving a display panel according to claim 4, wherein said cumulative total is obtained based on pixel data for one screen.

6. A method of driving a display panel according to claim 4, wherein the cumulative total is obtained based on each item of the pixel data that is associated with each pixel in a predetermined area of one screen.

7. A method of driving a display panel according to claim 4, wherein the cumulative total is obtained based on each item of the pixel data acquired in a predetermined period.

8. A method of driving a display panel according to claim 1, wherein items of the pixel data for one screen which have gray scale levels different from each other are stored in a memory and wherein said number of gray scale levels is obtained based on the number of the items of the pixel data stored in the memory.

9. A method of driving a display panel in which a display panel having a plurality of light-emitting devices serving as pixels arranged in the form of a matrix is driven in accordance with pixel data of each of the pixels based on a video signal, wherein
when the number of gray scale levels of an image represented by the video signal is greater than 2, each of the light-emitting devices is selectively caused to emit light in each of a plurality of sub-fields which together constitute a display period of one field of the video signal according to the pixel data, for a period associated with the sub-field and wherein
when the number of gray scale levels of the image represented by the video signal is 2 or less, each of the light-emitting devices is selectively caused to emit light according to the pixel data for the display period of one field.

10. A method of driving a display panel according to claim 9, wherein when the number of gray scale of the image represented by the video signal is 2 or less, the light-emitting device is caused to emit light according to the pixel data for the display period of one field, and a multi-gray scale processing on the video signal is stopped.

11. A method of driving a display panel according to claim 9, comprising the steps of:
obtaining a cumulative total of each of luminance levels in the pixel data for one screen;
generating cumulative total data representing the cumulative total in association with each of the gray scale levels; and
judging that the number of gray scale levels of the image represented by the video signal is 2 or less when the number of items of the cumulative total data having a cumulative total of 1 or more is two or less among the generated cumulative total data.

12. A method of driving a display panel according to claim 9, comprising the steps of:
obtaining a cumulative total of each of gray scale levels in the pixel data for one screen; and
judging that the gray scale of the luminance levels represented by the video signal is 2 or less when a ratio of a sum of items of data having a highest cumulative total and a second highest cumulative total to a total number of pixel data for one screen is higher than a predetermined ratio.
